(19) United States
(12) Patent Application Publication
(10) Pub. No.: US 2010/0129768 A1
(43) Pub. Date: May 27, 2010

(54) BONE MODELLING AND GUIDE DEVICE FOR PREPARING BONE SITES FOR IMPLANT SURGERY

(76) Inventor: Michel Isidori, Caluire et Cuire (FR)

Correspondence Address: HESLIN ROTHENBERG FARLEY & MESITI PC, 5 COLUMBIA CIRCLE, ALBANY, NY, 12203, US

(21) Appl. No.: 12/521,995

(22) PCT Filed: Dec. 24, 2007
(86) PCT No.: PCT/FR2007/052618

§ 371 Date: Dec. 8, 2009

(30) Foreign Application Priority Data
Jan. 2, 2007 (FR) 0700011

(51) Int. Cl. A61C 3/02

(52) U.S. Cl. 433/75

(57) ABSTRACT

A bone modelling and guide device comprises a one-piece cylindrical body arranged and defined by two adjacent and concentric cylindrical bearings, one external and the other internal. The external cylindrical bearing has at least two indexing features adjusting to complementary shapes formed on a band joined to a surgical guide. The internal bearing allows passage and guidance of a shaft of a drilling bit. A bottom end of the external cylindrical bearing is bevelled. The guide device can be locked in depth and in rotation during positioning of a body in the band.

The present invention describes:

1. An axial guidance device for preparing bone sites in general or dental surgery, in order to reduce the angular dispersion; this device procures a significant improvement in order to:

prevent the degradation of the tissues in minimally invasive surgery, by controlling the penetration depth,

expand the gingiva or mucosa before the passage of the terminal drill by a particular design,

prevent the rotation of the device and hence the risks of fracture of the surgical guide,

prepare the deficient bone sites very accurately while preventing deviations generated by the bone tables.

2. The corresponding preparatory tools for using the device regardless of the type of site to be prepared; ridge bursting, bone expansion, sub-antral elevation, bone sampling, drilling, implant positioning.

It is clearly understood that these devices and tools can be used to position implants for partial or total restorations using sealed or screwed prostheses, whether for surgery with flaps or minimally invasive surgery.

### TECHNICAL BACKGROUND OF THE INVENTION

For the time being, in dental surgery, the loss of one or more missing maxillary or mandibular teeth is very often experienced as a drama, and the installation of a removable prosthesis, in order to compensate for these dental losses, must not be considered as the best solution.

Fixed solutions, using prostheses anchored to one or more implants, can be proposed. The implants are screwed or impacted in the bone sites prepared in various ways.

The earliest technique required “extensive” bone surgery, where the bone sites were substantially exposed (by detaching the gingiva) in order to visualize the complex anatomy of the upper maxilla or the mandible, the bone sites were then prepared using drills of increasing diameter commensurate with the implants to be installed, and the gingival tissues were finally restored to their place, sutured, starting a healing phase of four to six months.

In recent years, modern medical imaging techniques, coupled with robotics, in combination with a radiological guide tested in a dental or mucosa support situation, have made the following possible:

computer planning of the precise position of implants according to the final prosthetic execution previously validated in the mouth,

transfer of these data to a robot for drilling the radiological guide and the study models along the planning axes and therefore,

transfer of the computer plan directly to the surgical site for executing the precise and little or non-mutilating surgery,

position the implants accurately,

obtain good results while reducing post-operative complications.

One of the techniques currently used, serving as a basis for the invention, was described in patent FR 2 760 349 and U.S. Pat. No. 6,296,483 B1. Among the other techniques currently tested and validated, it is necessary to refer to the surgical template developed and described in patent FR 2 836 372 “bone support template prepared by stereolithography and techniques for preparing bone sites using navigation principles”.

Lately, a patent describing the design of the implant guide and a guidance device was filed and published under number FR 2 882 250 in the name of the applicant.

Compared to the inventions of the prior art described above, the originality of this invention lies in the design of the guide device in order to achieve minimally invasive surgeries while not damaging the operated tissues, while controlling the penetration of the guide device according to the invention, hence by further providing greater safety in the drilling depth and more accuracy in the surgical acts.

At present, numerous publications praise the merits of computer aided surgery and the benefits of a prosthetic execution placed within a short post-operative time, but the accuracy provided appears to be haphazard, the piers connecting the prosthesis to the implants being expansive in order to compensate for axis errors.

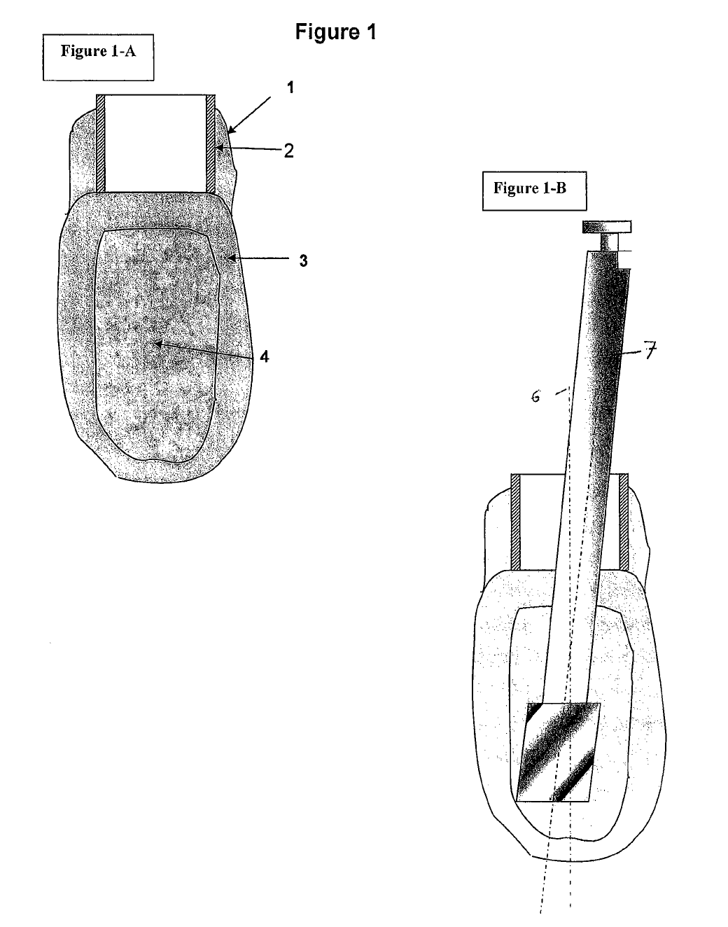

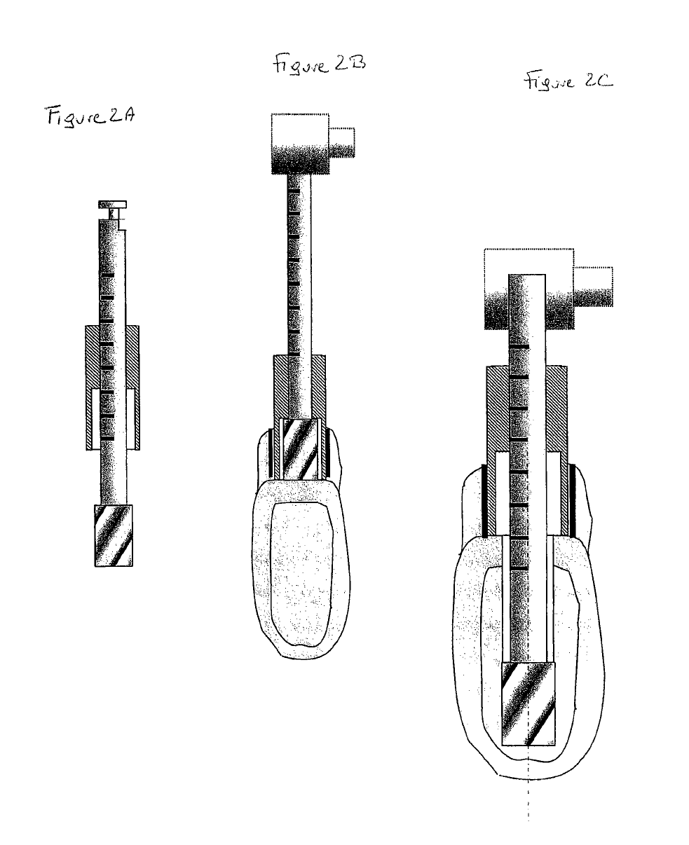

FIGS. 1 (1A-1B) show the abovementioned prior art.

FIG. 1: At the present time, practitioners use a surgical guide (1) placed on the gingiva (3) or the bone (4) (after having removed the flaps). This guide is either stabilised by the residual teeth, or by lateral screws. In general, the guide has been perforated manually, according to the positioning of the teeth of the wax up; some practitioners make 2 mm or wider perforations.

FIG. 1-A: In computer aided surgery, using the CaD-implant® system, the perforations are:

5.5 min in diameter through the resin guide in which surgical steel or titanium tubes (2) are inserted, in which tubes of increasing diameter are inserted in order to prepare the bone pits or:

5.0 mm in diameter, in which nesting tubes of increasing diameter are placed in order to prepare the bone pits.

FIG. 1-B, shows that during the drilling, some axis deviation is possible, especially when nesting tubes are not used. Their use provides substantial improvements to the axis prepared, compared to the desired axis, but due to the mechanical tolerance required between two sliding parts, a source of error exists. There is a difference between the axis planned during the programming (6) and the axis obtained (7), that is unacceptable in an “immediate loading”.

In order to produce accurate drillings to place the prepared prosthesis rapidly, it is obvious that the bone drilling technique must be improved. Many authors have described various drill guide techniques using tubes (nesting or not), of increasing diameter commensurate with the increasing diameter of the drills, but with the problems of mechanical tolerance, so that the desired accuracy for positioning a prosthesis prepared in advance can only be achieved with difficulty.

The present inventions, according to the prior art, relate to a universal drill axial guidance device to be used during the preparation of bone sites in general or dental surgery, in order to reduce the angular dispersion, to control the drilling depth, and to respect the tissues, this device being workable with the cutting tools (drills, trepans) described in patent application FR 2 882 250.

The guide device proposed in patent FR 2 882 250 served to remedy the problems of axis deviation. It has the form of a cylinder which is set in the surgical guides with an axial guidance of the drill, by forcing the latter to move exclusively along the bore axis.

However, it only provides relative accuracy in drilling depth, the drill being able to convey the guidance device axially up to the gingiva, and even sometimes up to the bone ledge, causing damage to this gingiva. Moreover, it rotates freely, sometimes causing fracture of the surgical guide.

FIG. 2 (2A-2B-2C) shows a diagram of the use of the guide device described in patent FR 2 882 250 in combination with new drills to be developed according to the invention. The proposed guide device allows work in the axis of the drill but offers no locking in the vertical direction and penetrates deeply, causing tissue injury by the rotation of the guide device. Moreover, the drilling depth is only controlled by visible inspection, without any safety. FIG. 2 shows the guide device according to this document.

### OBJECT OF THE INVENTION

It is the object of the present invention to remedy the drawbacks of the prior art.

The present invention relates to a modelling and guide device for preparing bone sites, and novel instruments for surgical bone preparation and implant positioning serving to provide the practitioner with safe, stressless surgery, enhancing his prosthetic treatment plan, and to the patient, a precise, fast, less evasive, more comfortable surgery.

1. An axial drill guide device during the preparation of bone sites in general or dental surgery, in order to reduce the angular dispersion, to respect the operated tissues and to adjust the penetration of the implant(s), that is the depth, so as to use the device regardless of the type of site to be prepared with regard to computer aided surgery.

2. This guide device also allows total guidance during the use of a guided implant holder, bone modelling tools (manual or mechanical expander, manual or mechanical sub-antral elevation tool commonly wrongly referred to as “osteotome”, bone shears, bone trapan or trephine).

3. The design of the novel tools

Thus, according to a first feature of the invention, the modelling and guide device is characterized in that it comprises a one-piece cylindrical body arranged and defined by two adjacent and concentric cylindrical bearings, one external, the other internal, and in that the external cylindrical bearing being prepared with at least two indexing means adjusting to complementary shapes formed on a band joined to a surgical guide, and in that the internal bearing allows the passage and guidance of the shaft of the drilling bit, and in that the bottom end of the external cylindrical bearing is bevelled, and in that the means lock the guide device in depth and in rotation during the positioning of the body in the band embedded in the surgical guide.

These features and others will clearly appear from the rest of the description.

The object of the invention is illustrated in a non-limiting manner, in the figures of the drawings in which:

FIG. 1, and its particulars views 1A and 1B, are views of the prior art.

FIG. 2, is a view of the prior art corresponding to patent FR 2 882 250.

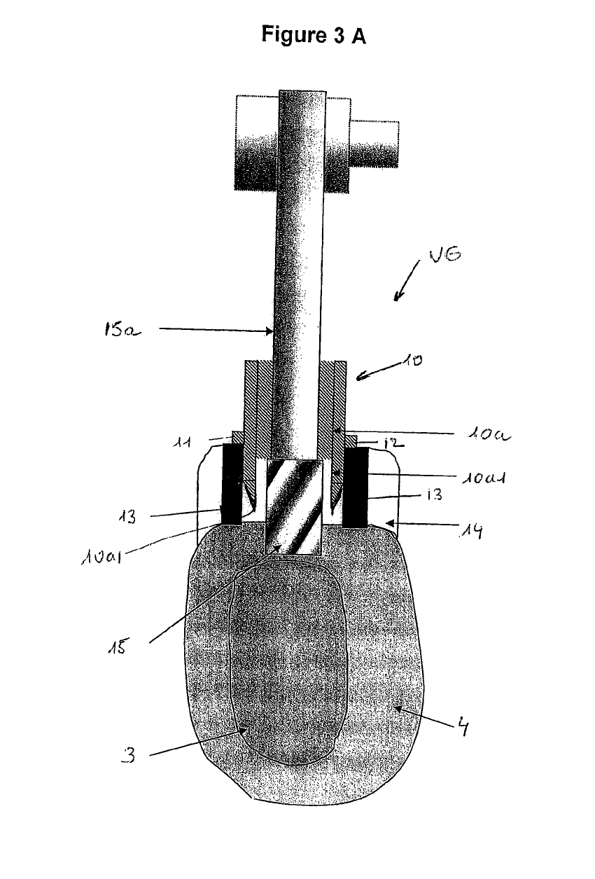

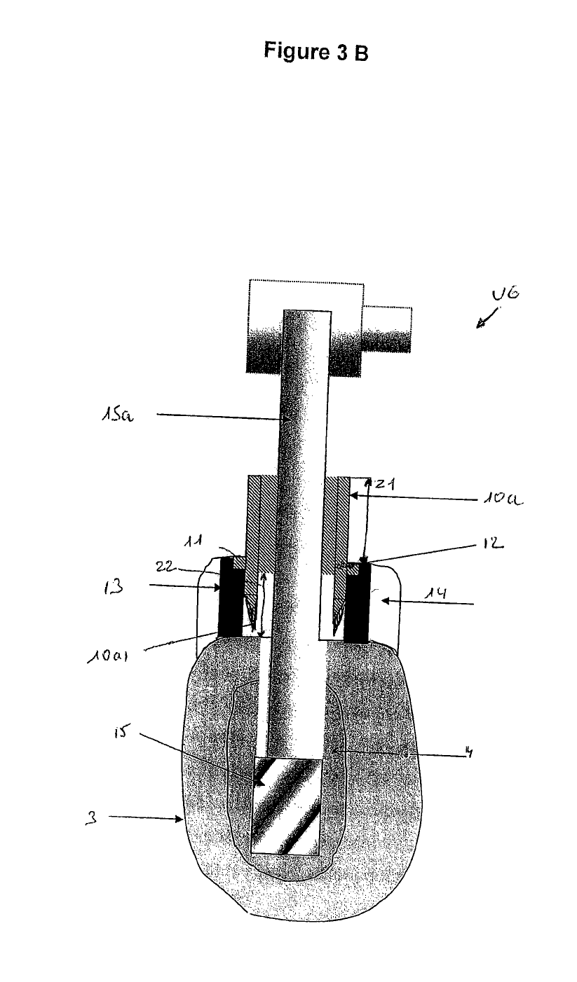

FIGS. 3A, 3B show the guide device according to the invention, in the initial phase, and then at the start of surgery.

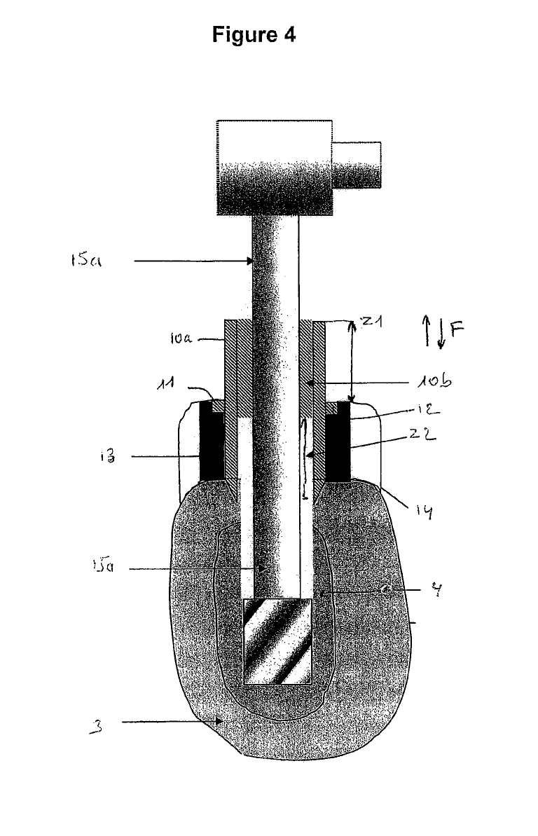

FIG. 4 shows the guide device of the invention in the contact phase with the mucosa or gingiva.

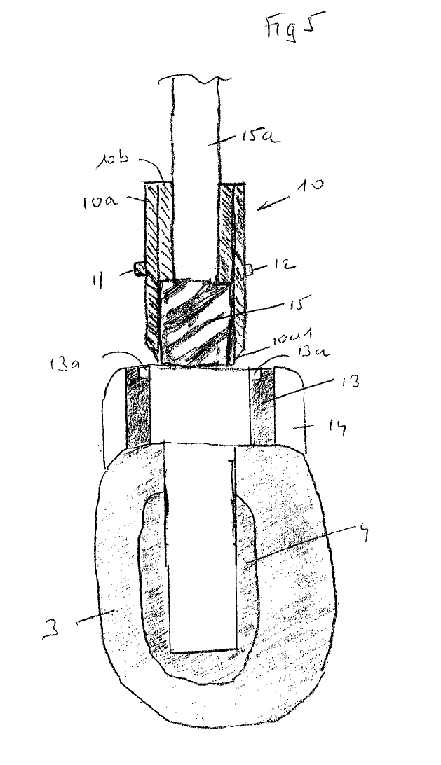

FIG. 5 is a partial view showing the extraction of the device.

To make the object of the invention more concrete, it is now described in a non-limiting manner illustrated in the figures of the drawings.

The modelling and guide device according to the invention, referenced as a whole by (UG), comprises a one-piece cylindrical body (10) arranged and defined by two adjacent and concentric cylindrical bearings (10a-10b), one external (10a), the other internal (10b). These two cylindrical bearings have a different or equal height. These two bearings have identical outside diameters and thus different inside diameters. This external cylindrical bearing (10a) is prepared with at least two indexing means (11-12) which may be external pins, slides or stops, diametrically opposed when there are two, and embedded in an equivalent number of complementary shapes (13a) of the groove or slot or peripheral spline type formed on a metal band (13) joined to a surgical guide (14) thereby locking the guide device both in rotation and in depth. The bottom end of the external cylindrical bearing (10a1) is bevelled. The internal cylindrical bearing is prepared in order to authorize the passage and guidance of the shaft (15a) of the receiving tool of the bit (15) itself constituting the drill.

According to an important feature, the cylindrical bearing (10a) defines two successive height zones (Z1-Z2), defined as follows. The zone (Z1) is the free emerging portion of the body after its positioning on the band (13). The zone (Z2) is the internal portion which is located in the band after positioning of the body in the band. The zone (Z2) has a constant height of about 5 mm. The zone Z1 has a variable height of about 3 to 20 mm, allowing control of the drilling depth and/or the preparation of the gingiva.

This medical device, according to the invention may be made of surgical steel, titanium or titanium alloy. P.I.C. or POM (PolyOxyMethacrylate), ceramic or zirconia and oxides thereof, or any other material usable in the biological and/or medical fields.

It is stipulated that this guide device (UG) combined with its band (13) can be used with any surgical guide (14) conventionally perforated or by directly inserting the guide device (UG) into the drilled guide comprising at least two diametrically opposed slots in pairs.

It is necessary to state that the movement of the bit and the guide shown, in FIGS. 3A, 3B, 4, is established along the arrow F in a vertical back-and-forth direction as required, and that the removal of the bit causes the removal of the guide body from the gingiva.

The drilling depth is controlled by the height of this zone Z1: it may vary from 3.0 mm to 15 mm. The maximum diameter of the internal cylindrical bearing (10b) 4.60 mm allows the use of all drill diameters or tools required during surgical implant operations, the depth of this bore is at least 5 mm and may vary according to the height of the operating portion of the universal drill, that is between 5 mm and 10 mm.

The inventive device is intended for guiding any tool used to prepare bone sites in surgery or implantology, whether mechanical or manual or pneumatic, and implant installation instruments. The end (10a1) of the cylindrical bearing (10a) of the guide device terminates at its end in a blunt bevel, in order to push the tissues, as shown in FIG. 4. To terminate the preparation of the implant site and for installing the implant, the guide device according to the invention is selected with a greater height of the portion (Z1) so that it descends in gingival or bone contact while expanding the mucosa.

All these explanations can confirm, for the practitioner, the major advantages that the inventive device provides to him and to the patient in terms of accuracy, safety, quality and speed, in terms of efficiency. This guide device (UG) and its band can obviously be used for any other computer aided surgical method or protocol, used as described or adapted to the technique employed.

Reference can be made to FIGS. 3A, 3B and 4 for the complementary features of the invention.

FIG. 3-A—The guide device proposed according to the invention can slide freely along the shaft of the drill or bone preparation tool with a very close tolerance;

The shaft of the tool has a millimetric marking allowing a first control of the penetration depth;

The guide device, having at least two pins or stops embedded in the band included in the surgical guide, cannot penetrate and damage the underlying tissues;

The depth is controlled by the choice of the height of the guide device in its upper portion which blocks the descent of the working instruments, at the travel limit; a second control is performed “visually” by the millimetric markings borne by the ends of the working instruments.

FIG. 3-B shows the inventive device in a real situation at the start of surgery, the guide device (10) sliding along the shaft of the drill type tool (15), in its upper portion or zone (Z1) while permanently controlling the penetration depth of the operating portion of the drill in the bone site by blocking the guide device in the band associated with the surgical guide and the variable height of the portion or zone (Z1) comprising the cylindrical bearing adapted to the diameter of the shaft of the cutting or preparation tool.

FIG. 4 shows the guide device adapted to the terminal preparation diameter of the bone site and for installing the implant. The guide device according to the invention is selected with a greater height of the portion of the zone Z2, in order to obtain a guide device—mucosa or gingiva contact: the bevelling of the guide device allows the outward thrust of the tissues.

In conclusion, the advantages of the inventive device are:
1. High accuracy in the surgical technique.
2. Simplicity of the guide device.
3. Depth control, respect of the tissues, safety.
4. Predictability, speed, traceability, little or no surgery.
5. Guide device according to the invention usable with the cutting instruments described in patent FR 2 882 250.
6. Development of an instrument, manual or mechanical, for preparing bone sites allowing guidance without deviation.
7. Guided implant device avoiding axis deviations compared to manual or mechanical positioning.

1. Bone modelling and guide device comprising a one-piece cylindrical body arranged and defined by two adjacent and concentric cylindrical bearings, said bearings including an external cylindrical bearing and an internal cylindrical bearing,
the external cylindrical bearing having at least two indexing means adjusting to complementary shapes formed on a band joined to a surgical guide,
the internal bearing allowing passage and guidance of a shaft of a drilling bit,
a bottom end of the external cylindrical bearing being bevelled,
and means for locking the guide device in depth and in rotation during the positioning of a body in the band,
and wherein the external cylindrical bearing defines two successive height zones, a first zone being a freely emerging portion of the body after positioning of the body in the band, and a second zone being an internal portion which is located in the band after positioning of the body in the band,
and the first zone has a variable height to control drilling depth and/or preparation of gingiva, and the second zone has a constant height.

2. Device according to claim 1, wherein the height of the first zone is defined between 3 and 15 mm, and the constant height of the second zone is defined at about 5 mm.

3. Device according to claim 1, in combination with the drilling bit, wherein the shaft of the bit has a millimetric marking for a first control of penetration depth.
